(19) United States
(12) Patent Application Publication
(10) Pub. No.: US 2005/0248047 A1
(43) Pub. Date: Nov. 10, 2005

(54) Compression molding method and apparatus suitable for making door facings

(76) Inventor: Manish Gupta, Aurora, IL (US)

Correspondence Address: BERENATO, WHITE & STAVISH, LLC, 6550 ROCK SPRING DRIVE, SUITE 240, BETHESDA, MD, 20817, US

(21) Appl. No.: 11/116,421

(22) Filed: Apr. 28, 2005

Related U.S. Application Data
(60) Provisional application No. 60/566,070, filed on Apr. 29, 2004.

(51) Int. Cl. B29C 43/02; B29C 43/58

(52) U.S. Cl. 264/40.1; 264/236; 264/322; 425/149

(57) ABSTRACT

A method for compression molding a thermoset article includes providing first and second movable mold dies providing a mold cavity. A thermosettable workpiece is placed on the first mold die. The workpiece is heated to a gel. At least one of the mold dies is moved toward the other to compress the workpiece between first and second die surfaces. A first mold clamp pressure is applied to the workpiece at a predetermined pressurization to shape the workpiece. The workpiece is cured into a thermoset article. An electrical property of the workpiece is measured as a function of time. A gelation period during which the electrical property changes in value until reaching a turning point corresponding to a gelation peak value is detected. A gelation peak time of the workpiece is determined, the gelation peak time coinciding with the gelation peak value.

### CROSS-REFERENCE TO RELATED APPLICATIONS AND CLAIM TO PRIORITY

This application is based upon provisional application No. 60/566,070, filed Apr. 29, 2004, the disclosure of which is incorporated herein by reference and to which priority is claimed.

### BACKGROUND OF THE INVENTION

1. Field of the Invention

The present invention is directed to a method and apparatus for molding thermosetting materials into shaped articles, especially door facings.

2. Description of the Related Art

Thermoset articles, also sometimes referred to in the art as thermosets, are commonly processed via compression molding. A compression mold apparatus generally comprises lower and upper dies having facing surfaces that are movable relative to one another. The facing surfaces are configured so that, when the dies are moved together into a closed state, a closed mold cavity is established and a mold clamp pressure is applied to thermosetting material in the mold cavity. The textures and configurations of the mold die facing surfaces are complementary to the desired texture and configuration of the thermoset article to be molded.

A solid or substantially solid material or “workpiece” that is capable of undergoing thermosetting, i.e., thermosettable, is placed on the facing surface of the lower die. One or both of the mold dies is/are heated (usually preheated) to a gelation temperature sufficiently high to melt the thermosettable workpiece into a gel during a gelation stage. As the workpiece melts on the lower mold die, the dies are moved relative to one another to close the mold cavity and press the gel into its desired shape. The velocity at which the dies are closed is commonly limited to avoid flashing and/or the creation of turbulent conditions that can lead to high porosity and other defects. Through continued application of heat and pressure, the workpiece crosslinks to harden into a thermoset article having a shape and texture conforming to that of the cavity-defining mold surfaces.

An example of an industry in which thermosetting materials are molded through the application of compression molding as described above is the door industry. Compression molded doors typically comprise a door-shaped wooden frame member, a polymeric foam-type core positioned within the frame member, a first door skin secured to a first side of the frame member, and a second door skin secured to a second side, opposite the first side, of the frame member to interpose the foam core between the door skins. The first and second door skins are often, but not necessarily, textured to provide the appearance of natural wood. The door skins also are preferably paintable, and durable for internal and external applications.

The door skins of compression molded doors commonly are comprised of a reinforced composite comprising a thermoset compound or compounds. For example, fiber-reinforced composites typically comprise a thermoset impregnated with glass fibers, although other reinforcing fibers and fillers are useful and known. The thermosetting workpiece introduced into the process is most commonly a sheet molding compound (SMC), such as modified or unmodified unsaturated polyester.

A problem that has been encountered in the production of composite door skins and other articles containing thermosetting materials is maintaining a consistent quality during successive molding operations. The compression molding process requires that a delicate balance be reached between the flow and cure of the thermosetting resin. The ability to maintain constant process conditions that reach a satisfactory balance between flow and cure may be compromised by a wide range of factors, including lot-to-lot variability in the properties, e.g., flowability and quality, of the thermosettable material and other ingredients. Deviations in ingredient concentrations and mold conditions from a desired predetermined standard also can contribute to difficulties in maintaining constant process conditions that balance flow and cure.

The aforementioned variations and deviations may adversely affect the quality of the thermoset article in many ways. For example, problems may arise in adequately spreading or distributing the workpiece during the gelation stage, leading to defects in the thermoset article such as high porosity, surface blisters, and “non-fills,” i.e., regions of the mold cavity to which the workpiece does not flow. Further, unstable or inappropriate cure conditions may cause the door skins to be non-conforming—e.g., “overcooked” or “undercooked”—during molding operations. Due to the difficulties involved in processing a cured thermoset, which by definition is irreversibly crosslinked and generally cannot be successfully remelted, the defective articles (e.g., door skins) are difficult to repair and often must be scrapped.

Consequently, it is desirable to be able to alter process conditions during or between compression mold operations to eliminate or substantially reduce the occurrence of defects in the compression molded thermoset article.

### SUMMARY OF THE INVENTION

It is an object of the present invention to provide a compression molding method suitable for making a composite shaped article, such as a door facing (or door skin), that prevents the occurrence or reduces the severity of a defect in the composite shaped article by detecting an electrical property of the thermosetting material during molding and using the property to control the compression molding process.

It is another object of the present invention to provide a method for controlling quality of a compression molding process for making thermoset articles, such as door facings (or door skins), by detecting an electrical property of the thermosetting material during molding and using the property to control the compression molding process as applied to subsequently processed thermoset articles.

It is another object of the present invention to provide a compression molding apparatus suitable for making composite shaped articles, such as door facings (or door skins), that avoids or substantially reduces the production of defective shaped articles by providing a sensor for detecting an electrical property of the thermosetting material and a controller for controlling the compression molding operation based on the electrical property detected.

Another object of the invention is to provide an assembly suitable for releasably and protectively retaining sensors in a mold die of a molding apparatus.

To achieve one or more of the foregoing objects, and in accordance with the purposes of the invention as embodied and broadly described herein, a first aspect of this invention provides a method for compression molding a thermoset article. According to this aspect, the method comprises providing a mold apparatus comprising a first mold die and a second mold die movable relative to one another between open and closed states, the first and second mold dies respectively having first and second surfaces facing one another to provide a mold cavity therebetween. A thermosettable workpiece is placed on the first mold die, and heated to gel the workpiece. At least one of the first and second mold dies is moved toward the other at a first closing velocity to compress the thermosettable workpiece between the first and second surfaces. Relative movement is continued to close the mold cavity, and a first mold clamp pressure is applied to the thermosettable workpiece in the closed mold cavity at a predetermined yet variable pressurization time to shape the thermosettable workpiece in the closed mold cavity. Through continued application of heat, the thermosettable workpiece is cured into a thermoset article. An electrical property of the thermosettable workpiece on the first die is measured as a function of time. From the measured electrical property, a gelation period is detected during which the measured electrical property changes in value as a function of time until reaching turning point (or extremum) corresponding to a gelation peak value. A gelation peak time of the thermosettable workpiece coinciding in time with the occurrence of the gelation peak value is determined.

In a preferred embodiment of this first aspect, the gelation peak value is compared to the predetermined yet variable pressurization time, and if the gelation peak time precedes the pressurization time by more than a predetermined tolerable allowance, at least one and optionally both of the first closing velocity and the first mold clamp pressure is changed to a second closing velocity and a second mold clamp pressure, respectively.

According to an embodiment of the first aspect, the step of changing the closing velocity and/or mold clamp pressure is performed on the same thermosettable workpiece that had its gelation peak time measured and compared to the pressurization time. According to another embodiment of this first aspect, the step of changing the closing velocity and/or mold clamp pressure is performed during processing of a subsequent, different workpiece, such as a successively processed second thermosettable workpiece. As explained herein, typically, the closing velocity will be increased in response to a determination that the gelation peak time is not occurring timely.

To achieve one or more of the foregoing objects, and in accordance with the purposes of the invention as embodied and broadly described herein, a second aspect of this invention provides a method for compression molding a thermoset article. According to this second aspect, the method comprises providing a mold apparatus comprising a first mold die and a second mold die movable relative to one another between open and closed states, the first and second mold dies respectively having first and second surfaces facing one another to provide a mold cavity therebetween. A curable thermosettable workpiece is placed on the first mold die and heated to gel. At least one of the first and second mold dies is moved toward the other to close the mold cavity and apply a mold clamp pressure to the thermosettable workpiece in the closed mold cavity. The thermosettable workpiece is heated in the mold cavity to a first cure temperature to induce cure of the thermosettable workpiece, usually after the workpiece has gelled. An electrical property of the thermosettable workpiece is measured as a function of time during a cure stage to provide a measured data set. The cure stage comprises a period from which the electrical property undergoes a turning point (or extremum) corresponding to a peak gelation value until substantially leveling off as a function of time. A measured cure rate of the thermosettable workpiece is determined from the measured data set.

In a preferred embodiment of the second aspect, the measured cure rate is compared to a predetermined cure rate standard. If the measured cure rate deviates from the predetermined cure rate standard by more than a predetermined tolerable allowance, the first cure temperature is changed to a second cure temperature.

According to an embodiment of this second aspect, the steps of comparing and changing are performed prior to completing cure of the thermosettable workpiece, so that the same thermosettable workpiece that had been subjected to the comparing step is cured at the second cure temperature. According to another embodiment of the second aspect, the second cure temperature is applied to a subsequently processed workpiece, such as a successively processed second thermosettable workpiece. It is within the scope of this embodiment for the first cure temperature to be greater than or less than the second cure temperature, wherein the increase or decrease in cure temperature depends upon the difference between the measured cure rate and the predetermined cure rate standard.

A third aspect for achieving one or more of the foregoing objects provides a compression molding apparatus comprising a first mold die having a first surface, and a second mold die having a second surface. The first and second surfaces face one another to form a mold cavity therebetween and to receive a thermosettable workpiece in the mold cavity. The apparatus of this aspect further comprises an actuator for moving the first mold die and/or the second mold die relative to the other at a first closing velocity between an open state and a closed state. The actuator also applies a first mold clamp pressure to the thermosettable workpiece in the closed mold cavity at a predetermined yet variable pressurization time. The apparatus further comprises a heat source for heating the thermosettable workpiece in the mold cavity to a gelation temperature at which the thermosettable workpiece melts. A sensor is provided for detecting a gelation period during which the measured electrical property changes in value until reaching a turning point corresponding to a gelation peak value. The apparatus further comprises a controller for determining a gelation peak time of the thermosettable workpiece, and preferably for comparing the gelation peak time to the predetermined yet variable pressurization time. The controller determines whether the gelation peak time precedes the pressurization time by more than a predetermined tolerable allowance. The controller optionally optionally is operatively associated with the actuator for changing at least one of the first closing velocity and the first mold clamp pressure to a second closing velocity and a second mold clamp pressure, respectively, in the event that the predetermined tolerable allowance is exceeded.

A fourth aspect for achieving one or more of the foregoing objects provides a compression molding apparatus comprising a first mold die having a first surface, and a second mold die having a second surface. The first and second surfaces face one another to form a mold cavity therebetween and to receive a thermosettable workpiece in the mold cavity. The apparatus further comprises an actuator for moving the first mold die and/or the second mold die relative to the other between an open state and a closed state. The actuator also applies a mold clamp pressure to the thermosettable workpiece in the closed mold cavity. The apparatus further comprises a heat source for heating the thermosettable workpiece in the mold cavity to a curing temperature at which the thermosettable workpiece cures. A sensor measures an electrical property of the thermosettable workpiece as a function of time during a cure stage for the thermosettable workpiece to provide a measured data set. The cure stage comprises a period from which the electrical property changes in value from a turning point corresponding to a gelation peak of the workpiece until substantially leveling off as a function of time. The apparatus further comprises a controller for determining a measured cure rate of the thermosettable workpiece. The controller preferably compares the measured cure rate to a predetermined cure rate standard and detects for a deviation between the measured cure rate and the predetermined minimum cure rate standard that exceeds a predetermined tolerable allowance. The controller optionally is operatively associated with the heat source for changing the curing temperature upon exceeding the predetermined tolerable allowance.

According to a fifth aspect of the invention, a sensor assembly is provided. The sensor assembly of this aspect is mountable into a mounting position on a compression molding tool having a molding surface with a bore. The sensor assembly comprises a sensor having a sensor face, a sensor cap releasably coupled to a bore-defining portion of the compression molding tool in the mounting position for positioning a face of the sensor cap substantially flush with the molding surface, and a locknut for releasably coupling the sensor to the sensor cap in the mounting position to position the sensor face substantially flush with the mold surface.

According to a sixth aspect of the invention, a door skin is provided comprising a surface, preferably an internal surface, having at least one indentation or protuberance substantially corresponding in shape to the head of a sensor assembly.

A seventh aspect of the invention provides a door assembly comprising a door-shaped frame, a foam core, first and second door skins positioned on opposite sides of the foam core, the first and second door skins each having a respective exterior surface and a respective interior surface, at least one of the interior surfaces having an imperfection selected from an indentation and a protuberance substantially corresponding in shape to the head of a sensor assembly.

### BRIEF DESCRIPTION OF THE DRAWINGS

The accompanying drawings are incorporated in and constitute a part of the specification. The drawings, together with the general description given above and the detailed description of the certain preferred embodiments and methods given below, serve to explain the principles of the invention. In such drawings:

FIG. 1 is a plan view with portions shown in phantom of an internal surface of a mold die according to an embodiment of the invention

FIG. 2 is a conductance-versus-time graph showing an ideal gel/cure cycle of a thermosetting workpiece, in which time is plotted on the abscissa (in seconds) and conductivity on the ordinate (in mhos);

FIG. 3 is a conductance-versus-time graph measured for a sheet molding compound subjected to a pressing speed of 10 inches/minute;

FIG. 4 is a conductance-versus-time graph measured for a sheet molding compound subjected to a pressing speed of 20 inches/minute;

FIG. 5 is a pre-assembled view of a sensor assembly, with portions shown in phantom;

FIG. 6 is a fragmentary cross-sectional view of the sensor assembly of FIG. 5, showing the sensor assembly mounted on a mold die; and

FIG. 7 is a diagram of an apparatus according to an embodiment of the present invention.

### DETAILED DESCRIPTION OF PREFERRED EMBODIMENTS AND PREFERRED METHODS OF THE INVENTION

Reference will now be made in detail to the presently preferred embodiments and preferred methods of the invention as illustrated in the accompanying drawings, in which like reference characters designate like or corresponding parts throughout the drawings. It should be noted, however, that the invention in its broader aspects is not limited to the specific details, representative assemblies and methods, and illustrative examples shown and described in this section in connection with the preferred embodiments and methods. The invention according to its various aspects is particularly pointed out and distinctly claimed in the attached claims read in view of this specification, and appropriate equivalents.

It is to be noted that, as used in the specification and the appended claims, the singular forms “a,” “an,” and “the” include plural referents unless the context clearly dictates otherwise.

The terms thermosettable and thermosetting are used interchangeably herein, although generally the term thermosettable is used primarily to describe workpieces capable of undergoing cure or crosslinking, whereas the term thermosetting is used to describe workpieces undergoing a state of cure or crosslinking.

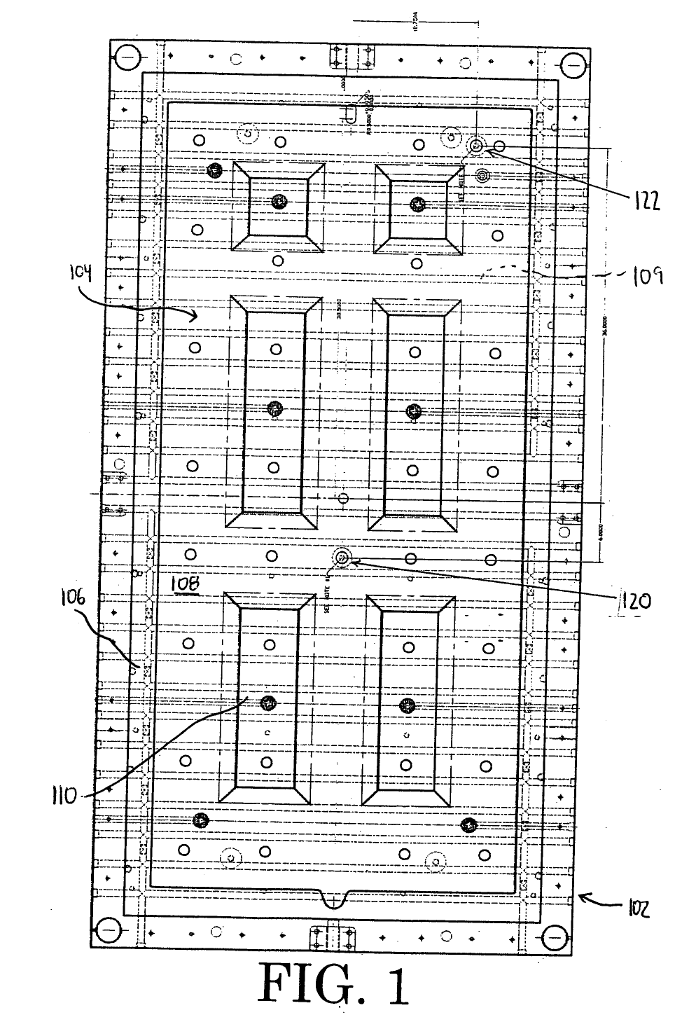

A method and apparatus for compression molding a thermoset article will now be described in detail. The embodiments described below make use of a mold apparatus for carrying out the compression molding technique. The methods of this invention are not necessarily limited to the mold apparatus described herein. Compression molding apparatus are well known in the art and commercially available. Generally, a compression molding apparatus comprises first and second mold dies, usually arranged one above the other as lower and upper mold dies. The first mold die and second mold die have respective internal surfaces facing one another. The internal surfaces collectively form a mold cavity for receiving a thermosettable workpiece (or charge). FIG. 1 shows an example of a mold die 102 having an internal surface 104 designed for molding a door skin, such as of a residential exterior door. The internal surface 104 has a configuration and optionally a texture complementary (or opposite) to that of the article to be molded in the mold cavity. As shown in FIG. 1, the internal surface 104 includes an outer trim-defining surface region 106, a main body-defining surface region 108, and a plurality of panel-defining surface regions 110 for shaping counterpart components of the door skin. Fluid channels 109, shown in phantom, allow for the passage of a heat source, such as heated oil, through the mold die 102 in order to achieve satisfactory cure of the thermoset.

The embodied methods and apparatus of the invention are described in this detailed description in connection with their preferred use of preparing a door skin. It is to be understood that these embodiments are illustrative yet not necessarily exhaustive of the scope of the invention. The methods and apparatus of the invention may be used for preparing other thermoset articles.

Compression molding apparatus further comprise an actuator or actuators operatively associated with one, and optionally both, of the mold dies to permit relative movement of the dies between the open and closed states. Known actuators include hydraulic and pneumatic piston and cylinder arrangements and presses, although other actuators are known in the art may be used within the scope of this invention. As referred to herein and in the appended claims, relative movement of a first mold die and a second mold die towards one another may comprise movement of the first mold die while retaining the second mold die stationary, movement of the second mold die while retaining the first mold die stationary, or simultaneous or sequential movement of both the first and second mold dies.

Compression molding apparatus still further comprise a heat source for melting and subsequently curing, i.e., crosslinking, the thermosettable workpiece. It is preferred that the heat source be incorporated into at least one, and optionally both of the first and second mold dies. It also is preferred for the heat source to preheat the mold die prior to workpiece introduction.

According to embodiments of the invention, a thermosettable charge (or workpiece) is placed on the lower mold die while the cavity is in its open state. The workpiece is preferably in a solid or substantially solid state when introduced on the lower mold die.

Examples of thermosettable materials suitable for use in this embodiment including sheet molding compounds (SMC) and bulk molding compounds (BMC). Sheet and bulk molding compositions generally comprise unsaturated/modified polyester resin(s) and one or more members selected from styrene monomer(s), shrink control agent(s), filler(s), reinforcement(s), and additive(s). The molding composition preferably includes a heat-activated curing agent (e.g., catalyst), optionally with a high temperature inhibitor for facilitating molding. Commercial products useful in aspects of the present invention include SL1200 manufactured by Premix, Inc. and 844M manufactured by Thyssen Krupp Budd.

The resin, styrene, and any shrink control agent are typically, but not necessarily, blended together prior to the addition of fillers, reinforcements and/or additives. Other polymeric materials also may be placed on the lower mold die for compression molding, e.g., as pre-blended or separately added ingredients. Examples of additional polymeric materials include viscoelastics such as polystyrene, polyvinyl acetate and saturated polyesters. Examples of polymeric resins are polyesters, vinyl esters, epoxies, phenolics, polyamides. Fillers may be used for various reasons, including for the purpose(s) of extending the resin, improving mold flow, and/or imparting desired characteristics. Examples of fillers include calcium carbonate, clay, graphite, magnesium carbonate, and mica. Examples of reinforcements include fiberglass, graphite, and aramides (e.g., in either glass fibers, microspheres, or mats). Other additives that may be used include, for example, mold release agents, shelf inhibitors, wetting agents, homogenizers, UV retardants, pigments, and/or thickeners.

Preferably, the heat source is preheated and begins heating the thermosettable workpiece as soon as the workpiece is placed on the lower mold die. The workpiece is heated to a temperature equal to or greater than the gel temperature of the thermosettable workpiece, causing the workpiece to undergo an initial gel (or melting stage) without significantly crosslinking (or curing). Preferably, the heated workpiece comprises a flowable resin or the like that is shapeable under pressurization in the mold cavity.

After the workpiece is placed on one of the mold dies, and preferably while the workpiece is beginning to gel, the first and second mold dies are relatively moved towards one another, i.e., either or both of the mold dies are moved, to compress the workpiece between the internal surfaces of the mold dies. Preferably, the thickness of the workpiece is greater than the thickness of the mold cavity, such that the workpiece is subjected to a compressive force between the first and second mold surfaces before the mold cavity is completely closed. The mold cavities continue to move until reaching a closed position, at which a mold clamping pressure is applied to the workpiece for shaping purposes. Heating is then continued, usually at the same temperature practiced for gelling, to crosslink and cure the shaped workpiece into a thermoset article.

Because the workpiece is most flowable and shapeable during its gelation stage, it is preferred to control mold die movement to coincide the gelation stage with mold closure and application of the mold clamping pressure. By closing and pressurizing the mold cavity before the gelation peak time, the gelled workpiece is permitted to distribute throughout the mold cavity before the onset of crosslinking. If the closing velocity is too slow, so that crosslinking has proceeded significantly prior to closure and mold clamp pressurization of the mold cavity, the thermosetting workpiece might not flow properly, resulting in defects such as blisters, non-fills, and porosity. On the other hand, high closing velocities may lead to entrapment of porosity-inducing air bubbles and generation of turbulence in the gelling thermosettable workpiece.

Accordingly, the timing and speed (also referred to herein as the closing velocity) at which the mold dies are moved into their closed position and the pressure with which the dies are pressed against one another in the mold clamping position are related to the gel and cure properties of the thermosettable workpiece. Control over these parameters can greatly influence the quality (or lack of quality) of the resultant article. According to embodiments of the present invention, mold conditions and/or operations are controlled with assistance of a sensor, such as a dielectric sensor.

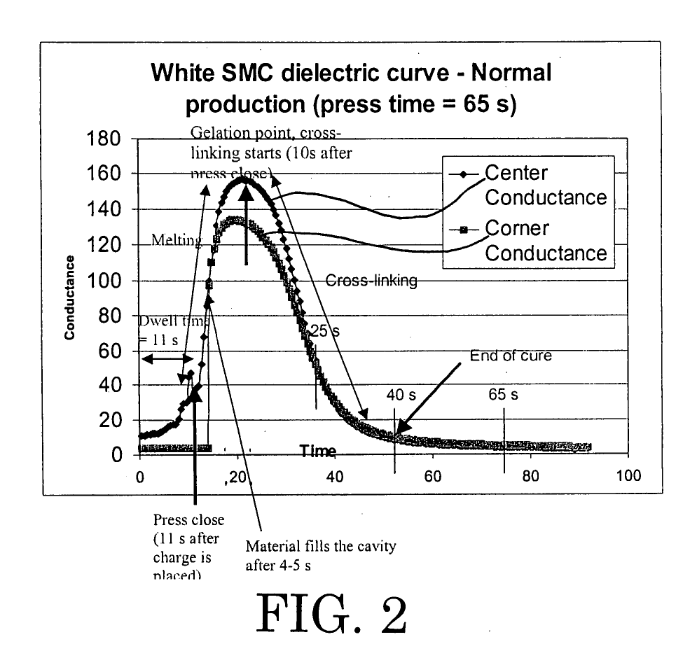

An ideal cure cycle is shown in FIG. 2, in which conductance (in mhos, which is the reciprocal of ohms) is plotted against time (in seconds) for a 65 second press time cycle. Plotting may be based, for example, on a 5000 Hz frequency. The conductance was measured using a first dielectric sensor positioned at the center of a mold die (or tool) and a second dielectric sensor positioned at one of the corners of the mold die. The facing surfaces of the mold dies were configured for pressing and curing door skins.

At t=0, a white sheet molding compound (SMC) workpiece was placed at the center of the mold tool and conductance measurements were taken on a real-time basis thereafter. The SMC began its gelling stage almost immediately, and the mold dies reached their closed state at t=11 seconds. It can be seen in FIG. 2, however, that the sensor at the center and the sensor at the corner of the mold cavity reported different electrical property values from one another during the gelation stage. The center (first) dielectric sensor, which corresponds to the location at which the thermosettable workpiece is placed, began taking measurements immediately, so that by the time the mold had closed at t=11 a conductance reading of about 40 mhos was taken at the center of the mold. On the other hand, the thermosettable workpiece was not initially placed at the corner of the mold cavity. As a consequence, the corner (second) dielectric sensor did not register readings until about t=15 seconds. The initial 15-second “dwell” period was caused by delayed flow and distribution of the SMC in the cavity. That is, the SMC was not sufficiently gelled and distributed until about t=15 to 16 seconds.

The SMC has a gelation period of about 21 seconds, i.e., from t=0 to t=21. During this 21-second gelation period, the SMC has an electrical conductance, as measured by the center sensor, that increases from an initial reading of about 10 mhos until reaching a maximum extremum or turning point at about 160 mhos. (The corner sensor increased from an initial reading of about 2 mhos to about 135 at the turning point, t=20 seconds, which was approximately one second before the peak value measured by the center sensor.) The turning point or maximum extremum corresponds to a gelation peak of the SMC. Without wishing to be bound by any theory, it is believed that the increase in electrical conductance over the gelation period is attributable to the movement of polar molecules in the thermosettable SMC.

Subsequent to reaching the gelation peak, the measured electrical conductance of the workpiece decreases in value below the extremum or turning point. Again without wishing to be bound by any theory, it is believed that the reduction in electrical conductance is due to restricting effect that curing (or crosslinking) has on the movement of polar molecules in the thermosetting workpiece. The rate at which the conductance drops corresponds to the cure rate of the thermosetting workpiece. Eventually, the conductance-versus-time curve passes through an inflection point, e.g., at about t=36 seconds in FIG. 2. It is estimated that crosslinking is approximately 95% complete at the inflection point. As the conductance-versus-time curve substantially levels out at around 51 seconds in FIG. 2, the curing stage arrives at or near its end.

According to a first embodiment of this invention, a method is provided for compression molding a thermoset article. This embodiment preferably is carried out to prevent the occurrence of or reduce the severity of defects arising during compression molding of the thermoset article. The method of this embodiment is especially useful in yet not necessarily limited to preventing or reducing defects arising or attributable to the gelation stage of the compression molding process.

According to this first embodiment of the invention, one of more electrical sensors, such as dielectric sensors, operatively communicating with the mold cavity take readings on a real-time basis and generate a measured data set of an electrical property, e.g., the electrical conductance or impedance, of the thermosettable workpiece as a function of time. Preferably, the readings are taken during all of the period in which the first and second mold dies compress the workpiece between the first and second mold surfaces, and continue at least until mold closure and application of a mold clamp pressing force. It is within the scope of this embodiment to take readings for only a portion of the period in which the first and second mold dies compress the workpiece. Readings may extend beyond this period, e.g., to the period before the workpiece on the mold die is compressed, and/or to the period after the mold cavity is closed and fully pressurizes the workpiece. It is preferred yet not required that readings be taken until and optional after the mold clamp pressurization time. It is further preferred yet not required that readings occur throughout the gelation stage.

The data set is used to detect a gelation period and a gelation peak time within the gelation period. The gelation period usually begins upon or shortly follows heating of the workpiece. Onset of the gelation period will depend upon various factors, such as the heating temperature, preheating of the mold dies, and the thermosettable material selected. In a conductance-versus-time graph of the type shown in FIG. 2, onset of the gelation period is manifested by an increase in conductance of the measured electrical property. When the measured electrical conductance reaches a maximum extremum or turning point, the gelation period has ended. The extremum or turning point corresponds in time to a gelation peak time, which marks the end of the gelation period.

Subsequent to the gelation peak time, the electrical conductance decreases in value (thus defining the turning point). For example, in FIG. 2 the gelation period starts at about t=0 and continues until reaching its peak value at about t=21 seconds, after which the electrical conductance decreases in value. Accordingly, the gelation peak time is t=21 seconds for FIG. 2. (Time t=0 corresponds to the time electrical conductance measurements are first taken, but does not necessarily correspond to the onset of the gelation period. If electrical property measurements are not taken until the gelation period has ended, then the measured conductance at t=0 is not a turning point and does not correspond to the gelation peak. A turning point or gelation peak in a conductance-versus-time graph may be identified by the presence of an increasing electrical conductance at t<tₚₑₐₖ, and a decreasing electrical conductance at t>tₚₑₐₖ. If no peak is detected, then the gelation peak time is taken to be at a time less than t=0.)

The measured gelation peak time is compared to the predetermined yet variable pressurization time at which the mold clamping force is applied to the workpiece. If the gelation peak time precedes the pressurization time by more than a predetermined tolerable allowance, the velocity at which the molds are closed is increased and/or the mold clamp pressure applied to the workpiece is changed, more preferably increased. (The pressurization time is therefore “variable” because the step of changing (e.g., increasing) the closing velocity will inherently change or vary the pressurization time, i.e., the workpiece will be subjected to the mold clamping force earlier than was predetermined.)

The predetermined tolerable allowance constitutes an acceptable margin of error that an operator is willing to allow during a process. For example, if the operator determines that the gelation peak time optimally occurs at or after the application of the mold clamping pressure, the operator may (or may not) be willing to tolerate a certain error. In this example, a predetermined tolerable allowance of 1-second means that the operator will accept or tolerate a gelation peak time occurring up to 1 second before the mold clamping pressure is applied. Optionally, the predetermined tolerable allowance may be set to zero, meaning that the operator will not accept or tolerate any error. Returning to the above example, a predetermined tolerable allowance of zero (0) requires that if the gelation peak time occurs before application of the mold clamp pressure, then the closing velocity and/or pressure will be increased.

The predetermined tolerable allowance may be selected subjectively by the operator or objectively based on successful or optimal runs or other criteria. The predetermined tolerable allowance may be set in units of seconds or fractions of a second.

This first embodiment of the invention may be practiced to detect operational defects in the compression molding of a given thermosettable workpiece and to prevent or reduce the severity of a defect in the same workpiece. To do so, a decision as to whether to change the closing velocity and/or mold clamp pressure is preferably made prior to application of the mold clamp pressure. The measured electrical property, e.g., conductance, is measured and compared during the period the workpiece is compressed between the first and second surfaces, but before application of the mold clamp pressure, so that the closing velocity and/or mold clamping pressure change may be timely implemented.

The first embodiment of the invention also is useful in preventing or reducing the severity of defects in the compression molding of subsequent or successive workpieces following the analyzed “first” workpiece. After the first workpiece has been discharged, the closing rate and/or the pressure applied to a subsequent (and optionally successive) workpiece or workpieces may be increased to avoid operation problems encountered with the first workpiece.

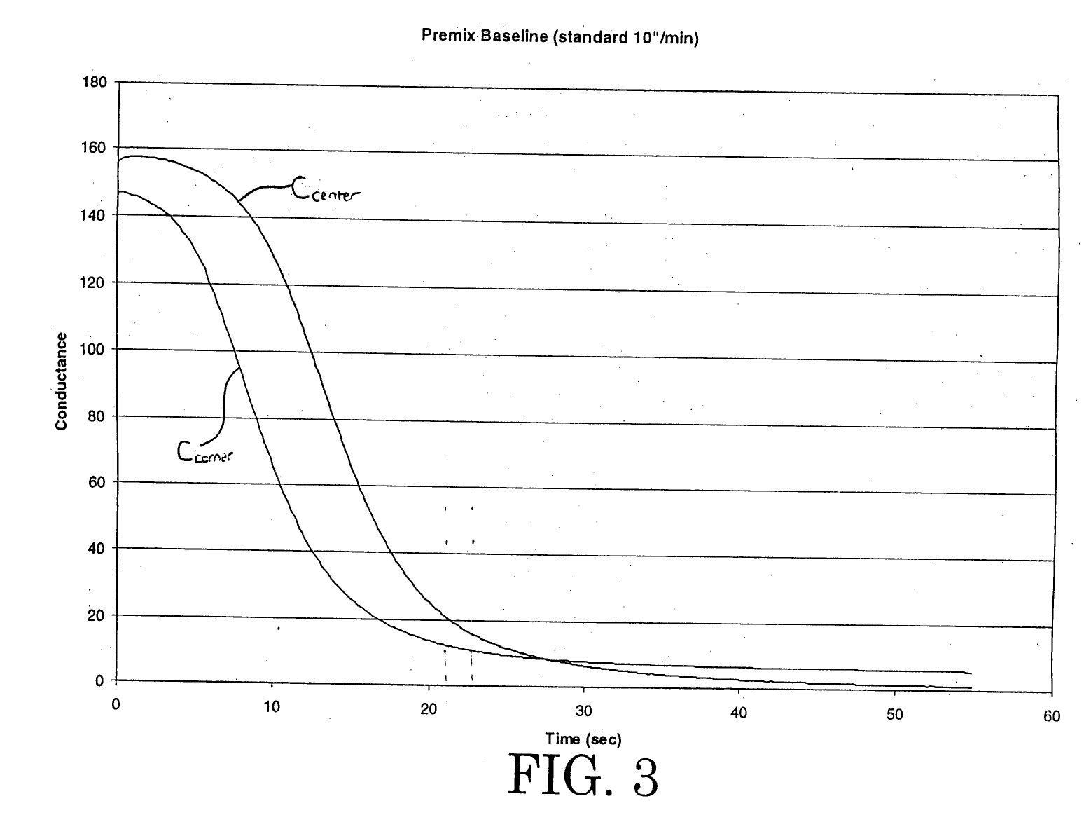

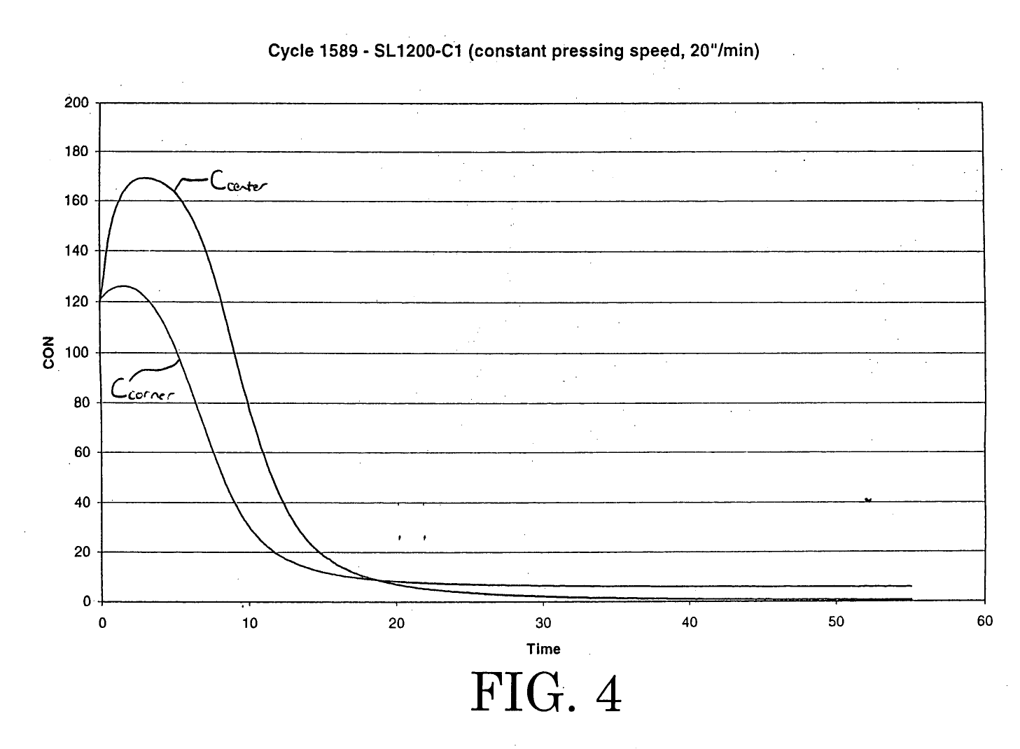

An example in which the first embodiment of the invention has been implemented is described with reference to FIGS. 3 and 4. FIG. 3 illustrates a conductance (mhos) versus time (seconds) curve for a thermosetting workpiece subject to a compression molding process in which a mold die was moved towards another mold die at a closing speed of 10 inches per minute. Electrical conductance readings are reported at t=0, which coincides in time to the application of a first mold clamp pressure to the workpiece, i.e., the pressurization time. Readings were taken for sensors located at the center of the mold die (corresponding to the curve C_{center} having a conductance of about 158 at t=0) and at the corner of the mold die (corresponding to the curve C_{corner} having an electrical conductance of about 148 at t=0). The center sensor exhibited a turning point corresponding to a gelation peak time of about 1 to 2 seconds, i.e., 1 to 2 seconds after application of the mold clamping pressure. However, the corner sensor did not exhibit a turning point before t=0, i.e., there was no initial increase in electrical conductance prior to reaching a maximum value. Thus, the gelation peak time for the center sensor occurred prior to time t=0.

FIG. 4 shows the effect of increasing the closing speed of the mold dies for a subsequently processed thermosetting workpiece to 20 inches per minute (from 10 inches per minute in FIG. 3). As shown in FIG. 4, the center sensor and corner sensor exhibited gelation peaks of about 170 and about 125, respectively. The center sensor and the corner sensor recorded gelation peak times of about 3 seconds and about 2 seconds, respectively. From this data, it is seen that by increasing the closing speed of the mold die(s), the gelation peak time occurs at both the corner and center of the mold cavity after the mold has been closed and pressurized, i.e., t=0. Accordingly, the gelled workpiece is allowed to fully distribute in the mold cavity prior to the onset of crosslinking.

A second embodiment of this invention provides a method for compression molding a thermoset article. This embodiment is preferably carried out to prevent the occurrence of or reduce the severity of defects arising during compression molding. The method of this embodiment is especially useful in yet not necessarily limited to preventing or reducing defects arising or attributable to the curing stage of the compression molding process.

According to this second embodiment of the invention, one of more sensors, such as dielectric sensors, operatively communicating with the mold cavity take readings and generate a measured data set of an electrical property, e.g., the electrical conductance or impedance, of the thermosettable workpiece as a function of time. Preferably, the readings are taken during the cure stage of the thermosettable workpiece to provide a measured data set. The cure stage comprises a period from which the electrical property changes in value from a turning point (or extremum) corresponding to a gelation peak until substantially leveling off as a function of time. Returning to FIG. 2, the cure period, as measured by the center dielectric sensor, starts at about t=21 seconds and ends at about t=51 seconds. It is within the scope of this embodiment to take readings for only a portion of the cure period. Readings may extend beyond the cure period, e.g., to the period before the workpiece reaches its gelation peak, and/or to the period after the measured electrical property (e.g., conductance) has substantially leveled off.

The measured data set of this embodiment is used to determine a cure rate of the thermosetting workpiece. The measured cure rate is compared to a predetermined cure rate standard and, if the measured cure rate deviates from the predetermined cure rate standard by more than a predetermined tolerable allowance, the first cure temperature is changed to a second cure temperature. For example, if the measured cure rate is faster, i.e., has a steeper slope, than the predetermined cure rate standard, then the first cure temperature may be lowered to a second cure temperature to slow the cure rate and avoid overcooking. On the other hand, if the measured cure rate is slower, i.e., has a smaller slope, than the predetermined cure rate standard, then the first cure temperature may be raised to a second cure temperature to hasten the cure stage and avoid undercooking.

As explained above, the predetermined tolerable allowance constitutes an acceptable margin of error that an operator is willing to allow during a process. Optionally, the predetermined tolerable allowance may be set to zero, meaning that the operator will not accept or tolerate any error. The predetermined cure rate standard and the predetermined tolerable allowance may be selected subjectivity by the operator or objectively based on successful or optimal runs or other criteria.

This second embodiment of the invention may be practiced to detect defects generated during the compression molding of a given thermosettable workpiece and to prevent or reduce the severity of a defect in the same workpiece. To do so, a decision as to whether to increase or decrease the first cure temperature to a second cure temperature is preferably made prior to the conductance-versus-time curve substantial leveling off. The electrical property, e.g., conductance, is measured and compared, and any resulting temperature changes are made during but before conclusion of the cure period.

The second embodiment of the invention is also useful in preventing or reducing the severity of defects in the compression molding of subsequent or successive workpieces following the analyzed “first” workpiece. After the first workpiece has been discharged, the cure temperature applied to a subsequent (and optionally successive) workpiece or workpieces may be changed to avoid operation problems encountered with the first workpiece.

In this detailed description heretofore, the electrical property used for determining rheological and cure properties of the workpiece and comparing these properties to standards has been electrical conductance. It is to be understood that electrical conductance may be measured directly, or indirectly by the measurement of electrical impedance. Additionally, electrical properties other than conductance, such as electrical impedance, may also be measured (directly or indirectly) and/or compared. Generally, electrical impedance is inversely related to conductivity. Accordingly, a thermosetting workpiece subjected to a compression molding process would produce an impedance-versus-time plot having a gelation peak represented by a minimum extremum or turning point.

In this detailed description heretofore, the changed/varied process conditions generally comprise closing velocity, clamp pressure, and/or cure temperature. It is to be understood that the scope of the invention further encompasses changing/varying other process conditions based on measured electrical properties, especially those process conditions affecting flow and cure of the thermosettable charge.

An embodiment of an apparatus according to the present invention will now be described in further detail. It is to be understood that the methods of the invention are not limited to implementation in the apparatus described below and herein.

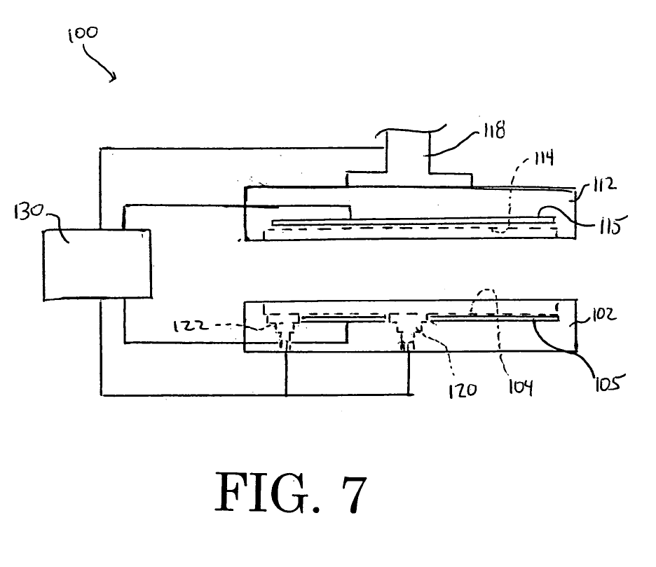

A simplified diagram of an apparatus 100 according to an embodiment of the present invention is shown in FIG. 7. The apparatus 100 comprises lower mold die 102 and upper mold die 112. Referring to FIGS. 1 and 7, the internal surface 104 of the lower mold die 102 conforms to the exterior appearance of a door skin. The internal surface 104 faces internal surface 114 of the upper mold die 112. An actuator 118 is connected to the upper die 112. The actuator 118 is selectively moldable in upward and downward directions at controlled speeds to move the upper mold die 112 between an open position (shown in FIG. 7) and a closed position, respectively. In the closed position, the mold dies 102 and 112 contact one another, and the actuator 118 may apply a further downward force, or mold clamping force, to the closed mold cavity.

Heat sources 105 and 115 selectively and controllably heat mold dies 102 and 112, respectively. The heat sources 105 and 115 may be internal or external to the mold dies 102 and 112.

The lower mold die 102 is provided with a central dielectric sensor 120 and a corner dielectric sensor 122, as shown in FIGS. 1 and 7. It is to be understood that more or less sensors may be used, and that the sensors may be located at alternative locations on the internal surface 104, including in regions other than the main body-defining surface region 108. The sensors 120 and 122 are capable of measuring an electrical property or electrical properties of the gelling and curing thermosetting workpiece, preferably in real-time to permit the gathering of rheological and/or cure information. Real-time dielectric impedance sensors are preferred and are commercially available, such as from Signature Control Systems of Denver, Co.

The sensors 120 and 122 are connected, e.g., electrically, to a controller 130, which may be mounted on or separately from the mold dies 102 and 112. Data representative of electrical properties of the thermosetting workpiece are sent from the sensors 120 and 122 to the controller 130 for processing. From the data, the controller 130 determines characteristics of the processed thermosetting workpiece, such as gelation peak time and/or cure rate, and compares the characteristics to predetermined standards. In the event that the characteristics measured by sensors 120 and 122 exceed a predetermined tolerable allowance, the controller 130 changes process conditions. For example, the controller 130 is operatively connected to actuator 118 to increase the closing velocity and/or mold clamp pressure if the measured gelation peak time exceeds the predetermined yet variable pressurization time by a predetermined tolerable allowance. The controller 130 is also operatively connected to the heat sources 105 and 115, allowing the controller to change the cure temperature in the event that the measured cure rate deviates from the predetermined cure rate standard by more than a predetermined tolerable allowance. A suitable controller 130 comprises a data acquisition such SMARTTRAC, supplied by Signature Control Systems. An analysis system or controller subsequently makes decisions to change closing time, mold clamp pressure, and/or cure temperature. Implementation of the changes may be made automatically by the analysis system or manually by the operator. The controller 130 and the analysis system may comprise a single controller or separate controllers.

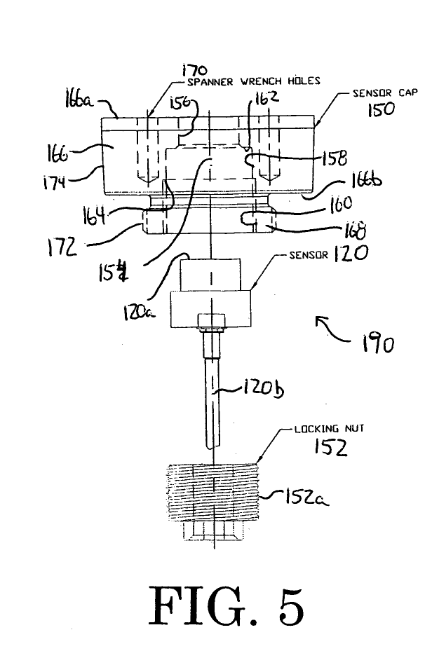

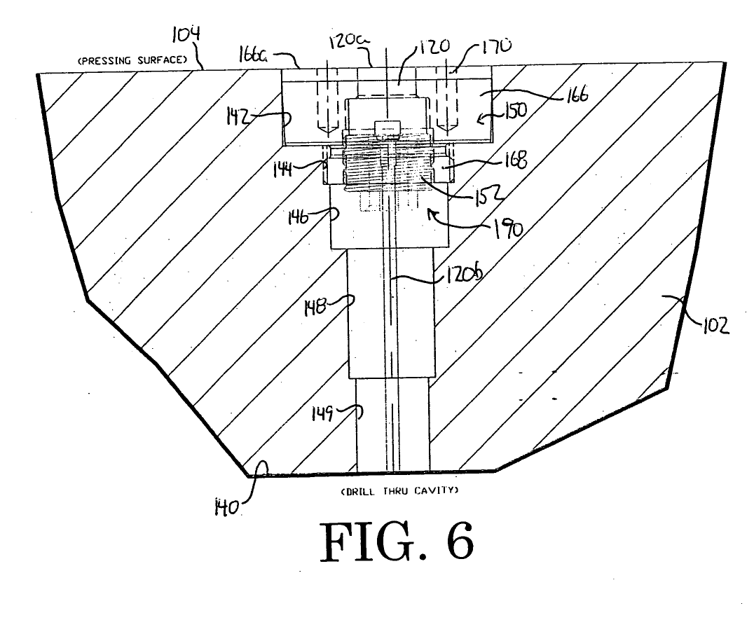

FIGS. 5 and 6 show a preferred yet not exhaustive embodiment for mounting the sensor 120 on the lower mold die 102. The lower mold die 102 has a drilled bore extending from the pressing surface 104 to an opposite surface 140 of the mold die 102. The bore comprises five step portions 142, 144, 146, 148, and 149. Step portion 144 is threaded.

A sensor cap 150 and locking nut 152 are provided for mounting the sensor 120 in the bore. The sensor cap 150 has a central passageway 154 having a first step region 156, a second step region 158, and a third step region 160. A first shoulder 162 is defined at the interface of the first and second step regions 156 and 158. A second shoulder 164 is defined at the interface of the second and third step regions 158 and 160. The third step region 160 comprises screw threads facing inwardly. The sensor cap 150 comprises a substantially cylindrical main body portion 166 and a ring portion 168. The central passageway 154 extends through both the main body portion 166 and the ring portion 168, which are coaxially aligned with one another and with the central passageway 154. The main body portion 166 has a first end surface 166a and a second end surface 166b. Spanner wrench holes 170 are formed in the first end surface 166a. The second end surface 166b is integrally connected to the ring portion 168 of the sensor cap 150. The ring portion 166 has a threaded outer surface 172, which is smaller in diameter than the substantially cylindrical outer surface 174 of the main body portion 166.

To assemble the sensor 120 to the mold die 102, the sensor 120 is inserted into the central passageway 154 from below the ring portion 168 of the sensor cap 150 until the sensor 120 is seated on the first shoulder 162 of the sensor cap 150. Preferably, the end 120a of the sensor 120 lies flush with the first end surface 166a of the main body portion 166. The locking nut 152 is then passed over the tail 120b of the sensor 120. The threaded external surface 152a of the locking nut 152 is mated with the screw threads of the third step region 160 of the ring portion 168. The locking nut 152 is driven into the third step region 160, preferably until abutting the second shoulder 164. As assembled, the sensor 120, sensor cap 150, and locking nut 152 define a sensor assembly 190.

The sensor assembly 190 is inserted into the lower mold die 102 from above, i.e., through the pressing surface 104. The threaded outer surface 172 of the ring portion 168 is allowed to mate with counterpart threads in the step portion 144. The spanner wrench holes 170 are used to rotate the sensor assembly 190 to drive the threads of the ring portion 168 into engagement with the threads of the step portion 144 until the sensor end 120a and first end surface 166a lie substantially flush with the pressing surface 104.

The sensor assembly 190 is removable from the lower mold die 102 by reversing the steps described above. This construction permits the sensor assembly 190 to be quickly installed and removed for replacement from the face of the mold die, without requiring disassembly of the mold die.

In the event that the sensor end 120a and/or the first end surface 166a do not lie substantially flush with the pressing surface 104, the sensor assembly 190 may mold a correspondingly shaped outline, protuberance, or indentation in the molded thermoset article. For this reason, the sensor assembly 190 preferably is placed on the mold die used to mold the hidden or internal surface of the door skin.

According to yet another embodiment of the invention, a method is provided for operating a first mold apparatus and a second mold apparatus substantially simultaneously. The first mold apparatus comprises opposing mold dies movable between open and closed states to form a first mold cavity, and a first sensor operatively associated with the first mold cavity. The second mold apparatus comprises opposing mold dies movable between open and closed states to form a second mold cavity, and a second sensor operatively associated with the second mold cavity. The first and second mold apparatus may include any of the other components and features of the embodiments described hereinabove.

First and second thermosettable workpieces are placed and processed in the first and second mold cavities, respectively, as described hereinabove.

Preferably, processing of the workpieces in the first mold apparatus and the second mold apparatus is substantially simultaneous. The first and second sensors measure electrical properties of the first and second thermosettable workpieces, respectively, during the gelation period and/or the cure period. The measurements taken by the first and second mold apparatus are compared to detect for a deviation therebetween, and optionally to compare the deviation to a predetermined tolerable deviation standard.

In the event that a deviation between the first mold apparatus and the second mold apparatus is detected, additional steps may then be taken to inspect for operational problems causing the defect and/or to correct such problems. For example, process parameters (e.g., closing velocity, mold clamping pressure, cure temperature, etc.) of the first apparatus and/or the second apparatus may be changed. Alternatively, the molded thermoset article(s) may be subjected to inspection and/or rejection upon detection of a deviation. Preferably, this embodiment is practiced to produce thermoset articles in the first mold apparatus that are of substantially equal quality to thermoset articles produced in the second mold apparatus.

Likewise, if the values reported by the corner sensor differ significantly from the values reported by the center sensor, then possibly a malfunction in the mold die heating system has occurred. Use of the invention with either one or two die sets therefore allows improved maintenance of the pressing system, further enhancing uniform quality of the door skins being produced.

Various advantages and benefits are provided by embodiments of the present invention. The method and apparatus of embodiments of the invention permit flow (rheological) and state-of-cure information to be ascertained in real time, permitting substantially instantaneous adjustment of compression molding settings and conditions to ensure continuous product quality and reduce waste and process uncertainties.

While this invention has been explained with regard to use of SMC materials, those skilled in the art will recognize that this invention may be used with other materials, such as wood fiber composites having a resin component.

The foregoing detailed description of the preferred embodiments of the invention has been provided for the purpose of explaining the principles of the invention and its practical application, thereby enabling others skilled in the art to understand the invention for various embodiments and with various modifications as are suited to the particular use contemplated. This description is not intended to be exhaustive or to limit the invention to the precise embodiments disclosed. Modifications and equivalents will be apparent to practitioners skilled in this art and are encompassed within the appended claims.

1. A method for compression molding a thermoset article, comprising:
providing a mold apparatus comprising a first mold die and a second mold die movable relative to one another between open and closed states, the first and second mold dies respectively having first and second surfaces facing one another to provide a mold cavity therebetween;
placing a thermosettable workpiece on the first mold die;
heating the thermosettable workpiece on the first mold die to gel the thermosettable workpiece;
moving at least one of the first and second mold dies toward the other at a first closing velocity to compress the thermosettable workpiece between the first and second surfaces;
closing the mold cavity and applying a first mold clamp pressure to the thermosettable workpiece at a predetermined yet variable pressurization time to shape the thermosettable workpiece in the closed mold cavity;
curing the thermosettable workpiece into a thermoset article;
measuring an electrical property of the thermosettable workpiece on the first mold die as a function of time;
detecting a gelation period during which the measured electrical property changes in value until reaching a turning point corresponding to a gelation peak value; and
determining a gelation peak time of the thermosettable workpiece, the gelation peak time coinciding in time with the gelation peak value.

2. A method according to claim 1, further comprising:
comparing the gelation peak time to the predetermined yet variable pressurization time and, if the gelation peak time precedes the pressurization time by more than a predetermined tolerable allowance, changing at least one of the first closing velocity and the first mold clamp pressure to a second closing velocity and a second mold clamp pressure, respectively.

3. A method according to claim 2, wherein said comparing and changing are performed prior to the pressurization time to apply at least one of the second closing velocity and the second mold clamp pressure to the thermosettable workpiece.

4. A method according to claim 2, wherein the thermosettable workpiece and thermoset article comprises a first thermosettable workpiece and a first thermoset article, respectively, and wherein the method further comprises:
discharging the first thermoset article from the mold cavity subsequent to said curing;
placing a second thermosettable workpiece on the first mold die subsequent to said discharging of the first thermoset article; and
processing the second thermosettable workpiece under at least one of the second closing velocity and the second mold clamp pressure.

5. A method according to claim 2, wherein said changing comprises increasing the first closing velocity to the second closing velocity.

6. A method according to claim 2, wherein said changing comprises increasing the first mold clamp pressure to the second mold clamp pressure.

7. A method according to claim 2, wherein said changing comprises increasing the first closing velocity and the first mold clamp pressure to the second closing velocity and the second mold clamp pressure, respectively.

8. A method according to claim 2, wherein the predetermined tolerable allowance is 0.

9. A method according to claim 1, wherein the mold cavity in the closed state conforms in shape to a door facing.

10. A method according to claim 1, wherein the curable thermosettable workpiece comprises a sheet molding compound.

11. A method according to claim 10, further comprising introducing reinforcing fibers into the mold cavity.

12. A method according to claim 11, wherein the reinforcing fibers comprise glass fibers.

13. A method according to claim 1, wherein said measuring comprises providing at least one of the mold dies with a dielectric sensor operatively associated with the mold cavity to gather data representative of Theological properties of the thermosettable workpiece, and measuring the electrical property with the dielectric sensor.

14. A method according to claim 1, wherein said measuring comprises providing the first mold die with first and second dielectric sensors operatively associated with the mold cavity to gather data representative of Theological properties of the thermosettable workpiece, and measuring the electrical property with the first and second dielectric sensors, the first dielectric sensor positioned to contact the thermosettable workpiece immediately when the thermosettable workpiece is placed in the first mold die, the second dielectric sensor positioned to contact the thermosettable workpiece after the thermosettable workpiece has been placed on the first mold die and subjected to compression.

15. A method according to claim 1, wherein the electrical property comprises electrical conductance, and wherein during the gelation period the measured electrical conductance increases in value until reaching the gelation peak value, the gelation peak value corresponding to a maximum measured electrical conductance value during the gelation period.

16. A method according to claim 1, wherein the electrical property comprises impedance, and wherein during the gelation period the measured electrical impedance decreases in value until reaching the gelation peak value, the gelation peak value corresponding to a minimum measured electrical impedance value during the gelation period.

17. A method for compression molding a thermoset article, comprising:
providing a mold apparatus comprising a first mold die and a second mold die movable relative to one another between open and closed states, the first and second mold dies respectively having first and second surfaces facing one another to provide a mold cavity therebetween;
placing a thermosettable workpiece on the first mold die;
heating the thermosettable workpiece on the first mold die to gel the thermosettable workpiece;
moving at least one of the first and second mold dies toward the other to close the mold cavity and applying a mold clamp pressure to the thermosettable workpiece in the closed mold cavity;
heating the thermosettable workpiece in the mold cavity to a first cure temperature to cure of the thermosettable workpiece; and
measuring an electrical property of the thermosettable workpiece as a function of time during a cure stage of the thermosettable workpiece to provide a measured data set, the cure stage comprising a period from which the electrical property changes in value from a turning point corresponding to a gelation peak until substantially leveling off as a function of time;
determining a measured cure rate of the thermosettable workpiece from the measured data set.

18. A method according to claim 17, further comprising comparing the measured cure rate to a predetermined cure rate standard and, if the measured cure rate deviates from the predetermined cure rate standard by more than a predetermined tolerable allowance, changing the first cure temperature to a second cure temperature.

19. A method according to claim 18, wherein said comparing and changing are performed prior to completing cure of the thermosettable workpiece, and wherein the method further comprises continuing cure of the thermosettable workpiece at the second cure temperature.

20. A method according to claim 18, wherein the thermosettable workpiece and thermoset article comprises a first thermosettable workpiece and a first thermoset article, respectively, and wherein the method further comprises:
discharging the first thermoset article from the mold cavity subsequent to cure;
placing a second thermosettable workpiece on the first mold die subsequent to said discharging of the first thermoset article; and
curing the second thermosettable workpiece at the second cure temperature.

21. A method according to claim 18, wherein the mold cavity in a closed state conforms in shape to a door facing.

22. A method according to claim 18, wherein when the measured cure rate is slower than the predetermined cure rate standard, said changing comprises increasing the curing temperature.

23. A method according to claim 18, wherein when the measured cure rate is faster than the predetermined cure rate standard, said changing comprises decreasing the curing temperature.

24. A method according to claim 18, wherein the predetermined tolerable allowance is 0.

25. A method according to claim 17, wherein the curable thermosettable workpiece comprises a sheet molding compound.

26. A method according to claim 25, further comprising introducing reinforcing fibers into the mold cavity.

27. A method according to claim 26, wherein the reinforcing fibers comprise glass fibers.

28. A method according to claim 17, wherein said measuring comprises providing at least one of the mold dies with a dielectric sensor operatively associated with the mold cavity to gather data representative of cure properties of the thermosettable workpiece, and measuring the electrical property with the dielectric sensor.

29. A method according to claim 17, wherein said measuring comprises providing the first mold die with first and second dielectric sensors operatively associated with the mold cavity to gather data representative of Theological properties of the thermosettable workpiece, and measuring the electrical property with the first and second dielectric sensors, the first dielectric sensor positioned to contact the thermosettable workpiece immediately when the thermosettable workpiece is placed in the first mold die, the second dielectric sensor positioned to contact the thermosettable workpiece after the thermosettable workpiece has been placed on the first mold die and subjected to compression.

30. A method according to claim 17, wherein the electrical property comprises electrical conductance, and wherein the cure stage comprising a period from which the electrical conductance decreases in value below the gelation peak until substantially leveling off as a function of time, the gelation peak value corresponding to a maximum electrical conductance value.

31. A method according to claim 17 wherein the electrical property comprises electrical impedance, and wherein the cure stage comprises a period from which the electrical impedance increases in value above the gelation peak until substantially leveling off as a function of time, the gelation peak value corresponding to a minimum electrical impedance value.

32. A compression molding apparatus for molding a thermoset article, comprising;
a first mold die having a first surface;
a second mold die having a second surface and movable relative to the first mold between an open state and a closed state, the first and second surfaces facing one another to form a mold cavity therebetween and to receive a thermosettable workpiece in the mold cavity;
an actuator for moving the second mold die relative to the first mold die at a first closing velocity and for applying a first mold clamp pressure to the thermosettable workpiece in the closed mold cavity at a predetermined yet variable pressurization time;
a heat source for heating the thermosettable workpiece in the mold cavity to a gelation temperature at which the thermosettable workpiece gels;
a sensor for detecting a gelation period during which a measured electrical property reaches a turning point corresponding to a gelation peak value;
a controller for determining the gelation peak time of the thermosettable workpiece; and
said controller comparing the gelation peak time to the predetermined yet variable pressurization time and determining whether the gelation peak time precedes the pressurization time by more than a predetermined tolerable allowance.

33. A compression molding apparatus according to claim 32, wherein said controller is operatively associated with the actuator for changing at least one of the first closing velocity and the first mold clamp pressure to a second closing velocity and a second mold clamp pressure, respectively, in the event that the predetermined tolerable allowance is exceeded.

34. A compression molding apparatus according to claim 32, wherein the mold cavity in the closed state conforms in shape to a door facing.

35. A compression molding apparatus according to claim 32, further comprising a sensor cap and a locking nut, wherein:
the first mold die has a bore extending therethrough for receiving the sensor;
the sensor cap is releasably coupled to a bore-defining portion of the first mold die and positioned substantially flush with the first surface; and
the locking nut releasably couples the sensor to the sensor cap to position an end of the sensor in operative association with the mold cavity.

36. A compression molding apparatus for molding a thermoset article, comprising:
a first mold die having a first surface;
a second mold die having a second surface and movable relative to the first mold between an open state and a closed state, the first and second surfaces facing one another to form a mold cavity therebetween and to receive a thermosettable workpiece in the mold cavity;
an actuator for moving the second mold die relative to the first mold die at a closing velocity and for applying a mold clamp pressure to the thermosettable workpiece in the closed mold cavity;
a heat source for heating the thermosettable workpiece in the mold cavity to a curing temperature at which the thermosettable workpiece cures;
a sensor for measuring an electrical property of the thermosettable workpiece as a function of time during a cure stage for the thermosettable workpiece to provide a measured data set representative of cure properties of the thermosettable workpiece, the cure stage comprising a period after which the electrical property changes in value from a turning point corresponding to a gelation peak until substantially leveling off as a function of time;
a controller for determining a measured cure rate of the thermosettable workpiece; and
said controller for comparing the measured cure rate to a predetermined cure rate standard and detecting for a deviation between the measured cure rate and the predetermined minimum cure rate standard that exceeds a predetermined tolerable allowance.

37. A compression molding apparatus according to claim 36, wherein said controller is operatively associated with the heat source for changing the curing temperature upon exceeding the predetermined tolerable allowance.

38. A compression molding apparatus according to claim 36, wherein the mold cavity in the closed state conforms in shape to a door facing.

39. A compression molding apparatus according to claim 36, further comprising a sensor cap and a locking nut, wherein:
the first mold die has a bore extending therethrough for receiving the sensor;
the sensor cap is releasably coupled to a bore-defining portion of the first mold die and positioned substantially flush with the first surface; and
the locking nut releasably couples the sensor to the sensor cap to position an end of the sensor in operative association with the mold cavity.

40. A sensor assembly mountable into a mounting position on a compression molding tool having a molding surface with a bore, comprising:
a sensor having a sensor face;
a sensor cap releasably coupled to a bore-defining portion of the compression molding tool in the mounting position for positioning a face of the sensor cap substantially flush with the molding surface;
a locknut for releasably coupling the sensor to the sensor cap in the mounting position to position the sensor face substantially flush with the mold surface.

41. A door skin comprising an internal surface and an external surface, at least one of the surfaces having at least one indentation or protuberance substantially corresponding in shape to the head of a sensor assembly.
